(19) United States
(12) Patent Application Publication
(10) Pub. No.: US 2008/0239054 A1
(43) Pub. Date: Oct. 2, 2008

(54) PRINTER

(75) Inventor: Yoshikazu KOIKE, Chino-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/060,747

(22) Filed: Apr. 1, 2008

(30) Foreign Application Priority Data
Apr. 2, 2007 (JP) 2007-096113
Feb. 6, 2008 (JP) 2008-026010

(51) Int. Cl. B41J 2/01

(52) U.S. Cl. 347/104

(57) ABSTRACT

A printer includes a transporting belt, a liquid ejecting head, and a negative pressure generator. The transporting belt transports a printing medium while electrostatically attracting the printing medium. The liquid ejecting head ejects liquid droplets onto the printing medium transported by the transporting belt and thereby performs printing. The negative pressure generator is in contact with the inner surface of the transporting belt and supports the transporting belt. The negative pressure generator has a suction opening for generating negative pressure formed in a contact surface thereof in contact with the transporting belt. The transporting belt is a substantially airtight member.

### BACKGROUND

1. Technical Field

The present invention relates to a printer that performs printing by ejecting liquid droplets from a liquid ejecting head onto a printing medium electrostatically attracted and transported by a transporting belt.

2. Related Art

Examples of this type of printer include a fixed head type ink jet printer that electrostatically attracts a charged printing medium onto a transporting belt and transports the printing medium, that ejects (discharges) liquid (ink droplets) from nozzle rows of a liquid ejecting head (ink jet head) formed in a direction perpendicular to the transportation direction and across the width of the transporting belt, and that thereby performs printing on the printing medium.

In such an ink jet printer, when the transporting belt rotates at high speed, the transporting belt flutters at its natural frequency, thereby fluctuating the distance between the ink jet head and the printing medium. In the nozzle rows, the time between discharge of an ink droplet and impact thereof on the printing medium can fluctuate, and therefore the impact position can fluctuate in the direction of transportation of the printing medium.

Fluctuation in the impact position of an ink droplet can cause deterioration in printing quality. For example, when an image in a desired color is formed by superposing ink droplets discharged from a plurality of nozzles, the dot superposition accuracy can deteriorate, and therefore a color different from the desired color can be produced, or color can change along the direction of transportation of the printing medium, and therefore color shading can occur in the printed image.

In order to improve the quality of printed image, for example, JP-A-2002-145474 discloses a printer that has a transporting belt attractor disposed inside a transporting belt to electrostatically attract the transporting belt and that suppresses the flutter of the transporting belt by attracting the transporting belt.

In the above known ink jet printer, a charged printing medium is electrostatically attracted onto the transporting belt, and the inner surface of the transporting belt is electrostatically attracted onto the transporting belt attractor. Therefore, when the charge amount of the printing medium is changed according to the material or humidity, the electrostatic attraction of the transporting belt attractor on the transporting belt is also changed. Decreased electrostatic attraction on the transporting belt can decrease the flutter-suppressing effect on the transporting belt. Increased electrostatic attraction on the transporting belt can increase the frictional resistance between the transporting belt and the transporting belt attractor and therefore can deteriorate the accuracy of transportation of the printing medium.

### SUMMARY

An advantage of some aspects of the invention is to provide a printer in which the attraction on a transporting belt can be prevented from changing when the amount of charge for attracting a printing medium is changed.

According to an aspect of the invention, a printer includes at least one transporting belt, a liquid ejecting head, and a negative pressure generator. The at least one transporting belt transports a printing medium while electrostatically attracting the printing medium. The liquid ejecting head ejects liquid droplets onto the printing medium transported by the transporting belt and thereby performs printing. The negative pressure generator is in contact with the inner surface of the transporting belt and supports the transporting belt. The negative pressure generator has a suction opening for generating negative pressure formed in a contact surface thereof in contact with the transporting belt. The transporting belt is a substantially airtight member.

Due to this structure, the transporting belt can be sucked by negative pressure. Unlike, for example, electrostatically attracting the transporting belt, the attraction on the transporting belt can be prevented from changing when the amount of charge for attracting the printing medium is changed.

The contact surface of the negative pressure generator may be provided with a plurality of holes and be flat.

Alternatively, the portion of the contact surface of the negative pressure generator opposite the nozzles of the liquid ejecting head may be flat.

In this case, since the transporting belt is sucked against the flat portion at a position where liquid droplets are ejected by the liquid ejecting head, the flatness at the position can be improved, and the distance between the liquid ejecting head and the printing medium can be prevented from changing.

It is preferable that the negative pressure generator have a low friction member on the contact surface thereof in contact with the transporting belt.

In this case, the sliding load can be reduced when the transporting belt slides on the contact surface of the negative pressure generator, and the accuracy of transportation of the printing medium can be improved.

It is also preferable that the transporting belt have a low friction member on a contact surface thereof in contact with the negative pressure generator.

In this case, the sliding load can be reduced when the transporting belt slides on the contact surface of the negative pressure generator, and the accuracy of transportation of the printing medium can be improved.

The negative pressure generator may have a plurality of rollers in the contact surface thereof in contact with the transporting belt. The plurality of rollers are disposed at predetermined intervals in the direction of transportation of the printing medium and rotate in the moving direction of the transporting belt.

In this case, with the rotation of the transporting belt, the rollers in contact with the transporting belt rotate. Therefore, the sliding load can be reduced when the transporting belt slides on the contact surface of the negative pressure generator, and the accuracy of transportation of the printing medium can be improved.

It is preferable that the rollers be disposed opposite nozzles of the liquid ejecting head.

In this case, at a position where liquid droplets are ejected by the liquid ejecting head, the flatness of the printing medium transported by the transporting belt can be improved, and the distance between the liquid ejecting head and the printing medium can be prevented from changing.

The at least one transporting belt may include a plurality of transporting belts disposed at predetermined intervals in a direction perpendicular to the direction of transportation of the printing medium, and the liquid ejecting head may eject liquid droplets onto a region of the printing medium out of contact with the transporting belts.

### BRIEF DESCRIPTION OF THE DRAWINGS

The invention will be described with reference to the accompanying drawings, wherein like numbers reference like elements.

FIGS. 1A and 1B schematically show the structure of an ink jet printer of a first embodiment. FIG. 1A is a plan view, and FIG. 1B is a side view.

FIG. 2 is a block diagram showing the internal structure of the ink jet printer.

FIGS. 3A and 3B show the structure of a suction unit. FIG. 3A is a plan view, and FIG. 3B is a side view.

FIGS. 4A and 4B illustrate the operation of the ink jet printer.

FIGS. 5A and 5B show the structure of a modification of the suction unit. FIG. 5A is a plan view, and FIG. 5B is a side view.

FIGS. 6A and 6B schematically show the structure of an ink jet printer of a second embodiment. FIG. 6A is a plan view, and FIG. 6B is a side view.

FIG. 7 shows the structure of a suction unit.

FIG. 8 shows the structure of a modification of the suction unit.

### DESCRIPTION OF EXEMPLARY EMBODIMENTS

Embodiments of the invention will hereinafter be described with reference to the drawings by taking, as an example of a printer of the invention, an ink jet printer that discharges ink and thereby records characters and/or images on a printing medium.

### First Embodiment

### Structure

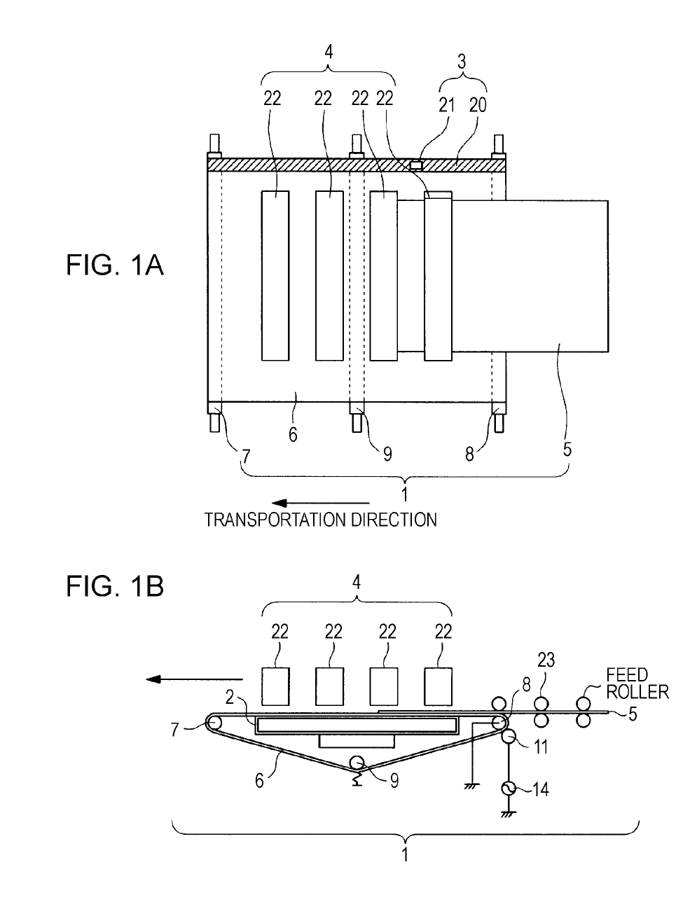

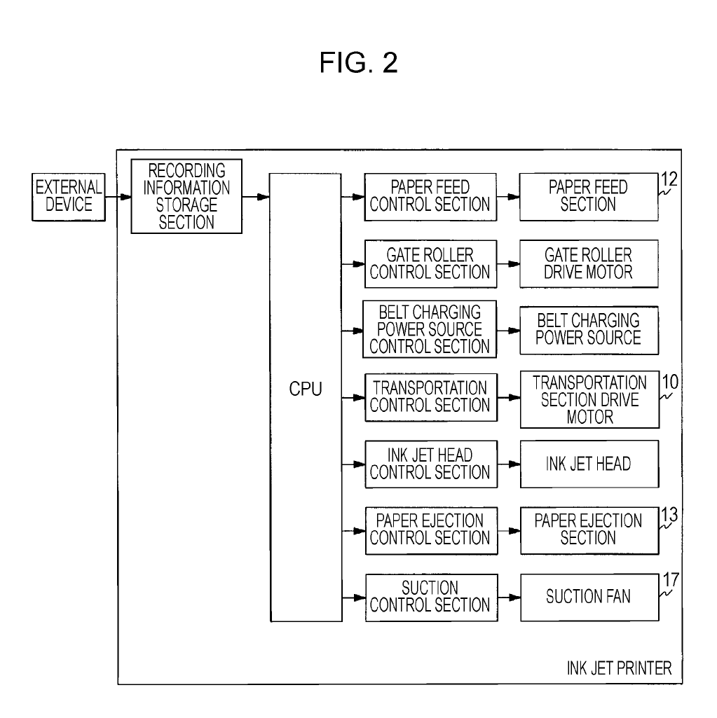

FIGS. 1A and 1B schematically show the structure of an ink jet printer of this embodiment. FIG. 2 is a block diagram showing the internal structure of the ink jet printer.

As shown in FIGS. 1A and 1B, the ink jet printer includes a paper transporting unit 1, a suction unit 2, a magnetic encoder 3, and a head unit 4.

The paper transporting unit 1 includes an endless transporting belt 6 disposed along the direction of transportation of a printing medium 5; a drive roller 7, an idler roller 8, and a tension roller 9 around which the transporting belt 6 is stretched; and a transportation section drive motor 10 that rotationally drives the drive roller 7.

In the paper transporting unit 1, the transportation section drive motor 10 rotationally drives the drive roller 7, and thereby the transporting belt 6 is rotated. The transporting belt 6 is electrostatically charged by a charging roller 11. The printing medium 5 fed from a paper feed section 12 is electrostatically attracted onto the upper surface of the transporting belt 6 and is transported under the head unit 4 and then to a paper ejection section 13, that is, in the direction of arrows in FIGS. 1A and 1B.

The contact surface of the transporting belt 6 in contact with the suction unit 2 is coated with a material having a low coefficient of friction such as fluoropolymer to reduce the sliding load occurring when the transporting belt 6 slides on the upper surface of the suction unit 2, and so that the transporting belt 6 can rotate stably.

An AC voltage of a predetermined frequency is applied to the charging roller 11 from an AC source 14. With the grounded idler roller 8 serving as a counter electrode, an alternating charge pattern is formed on the transporting belt 6.

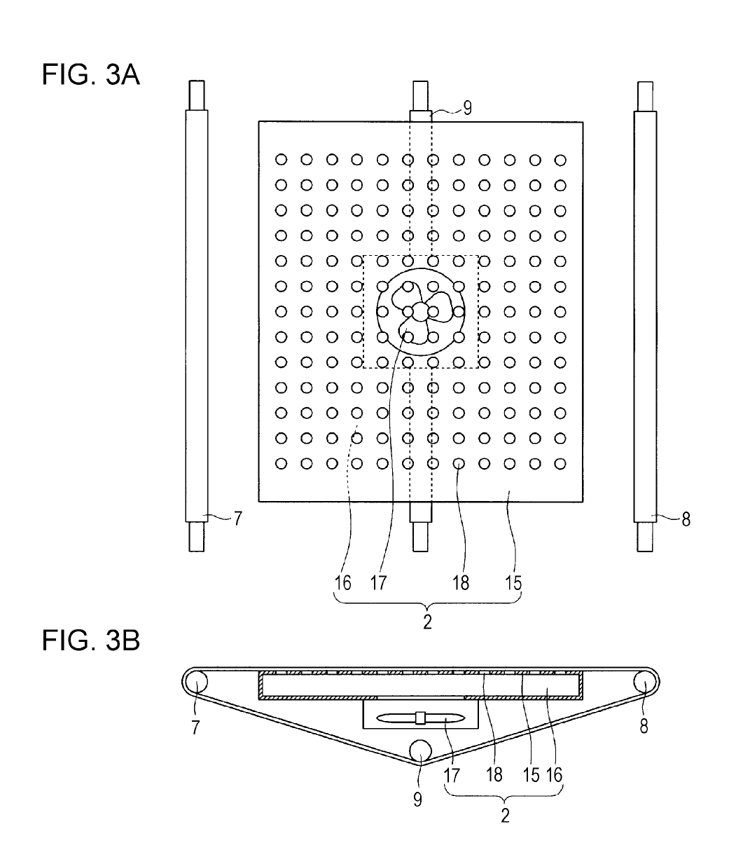

The suction unit 2 is disposed inside the transporting belt 6. As shown in FIGS. 3A and 3B, the suction unit 2 includes a flat plate member 15, a suction chamber 16, and a suction fan 17.

The flat plate member 15 is disposed opposite the nozzles of the head unit 4, is in contact with the lower surface of the transporting belt 6 so as to support the transporting belt 6, and has through-holes 18 provided in the contact surface thereof in contact with the transporting belt 6.

The contact surface of the flat plate member 15 in contact with the transporting belt 6 is coated with a material having a low coefficient of friction such as fluoropolymer to reduce the sliding load occurring when the transporting belt 6 slides on the upper surface of the suction unit 2, and so that the transporting belt 6 can rotate stably.

The suction chamber 16 is disposed so as to cover the lower surface of the flat plate member 15. The suction fan 17 sucks in air to generate negative pressure in the through-holes 18 in the contact surface of the flat plate member 15 in contact with the transporting belt 6 and so that the transporting belt 6 is sucked against the contact surface.

The transporting belt 6 is formed of a substantially airtight member (for example, a member without through-holes) so that the transporting belt 6 can be effectively sucked by the generated negative pressure. Therefore, the negative pressure generated in the suction chamber 16 does not contribute to the suction of the printing medium 5 and contributes only to the suppression of the flutter of the transporting belt 6.

The suction fan 17 is rotationally driven by a fan motor (not shown), sucks in the air in the suction chamber 16, and discharges the air downward.

The magnetic encoder 3 includes an encoder scale 20 and an encoder sensor 21.

The encoder scale 20 is disposed on an edge of the transporting belt 6 so as not to interfere with the printing medium 5. In the encoder scale 20, magnetic signals are written at regular pitches along the direction of transportation of the printing medium 5.

The encoder sensor 21 detects the magnetic signals written in the encoder scale 20, at a fixed position, thereby detects positional information of the transporting belt 6, and outputs the detection result to the head unit 4.

The head unit 4 is disposed over the transporting belt 6 and includes yellow (Y), magenta (M), cyan (C), and black (K) ink jet heads 22₁ to 22₄ arranged in the direction of transportation of the printing medium 5.

Based on positional information of the transporting belt 6 output from the encoder sensor 21, the head unit 4 discharges ink droplets downward from nozzle rows of the ink jet heads 22₁ to 22₄, thereby performing printing on the printing medium 5.

Technologies for driving the ink jet heads 22₁ to 22₄ include electrostatic actuator technology, piezoelectric technology, and film boiling technology.

### Operation

Next, the operation of the ink jet printer of this embodiment will be described.

First, upon request to start printing, the transportation section drive motor 10 is driven so as to rotate the transporting belt 6, and the fan motor is driven so as to suck the lower surface of the transporting belt 6 against the suction unit 2.

The paper feed section 12 sends a printing medium 5 to the gate roller 23. The charging roller 11 electrostatically charges the transporting belt 6. Thereafter, the gate roller 23 is rotated so as to feed the printing medium 5 onto the upper surface of the transporting belt 6. The printing medium 5 is electrostatically attracted onto the transporting belt 6 and is transported under the head unit 4 and then to the paper ejection section 13.

At the same time, a timer is activated. When a predetermined time has elapsed since activating the timer and the printing medium 5 passes under the head unit 4, the head unit 4 discharges ink droplets so as to perform printing on the printing medium 5. Thereafter, the printing medium 5 is ejected into the paper ejection section 13.

In this embodiment, the suction unit 2 of FIG. 1B serves as a negative pressure generator.

### Advantages

(1) As described above, the ink jet printer of this embodiment includes the suction unit 2 that is in contact with the inner surface of the transporting belt 6 so as to support the transporting belt 6 and that has the through-holes 18 for generating negative pressure formed in the contact surface thereof in contact with the transporting belt 6. Therefore, the transporting belt 6 can be sucked by negative pressure. Unlike, for example, electrostatically attracting the transporting belt 6, the attraction of the suction unit 2 on the transporting belt 6 can be prevented from changing when the amount of charge for attracting the printing medium 5 is changed.

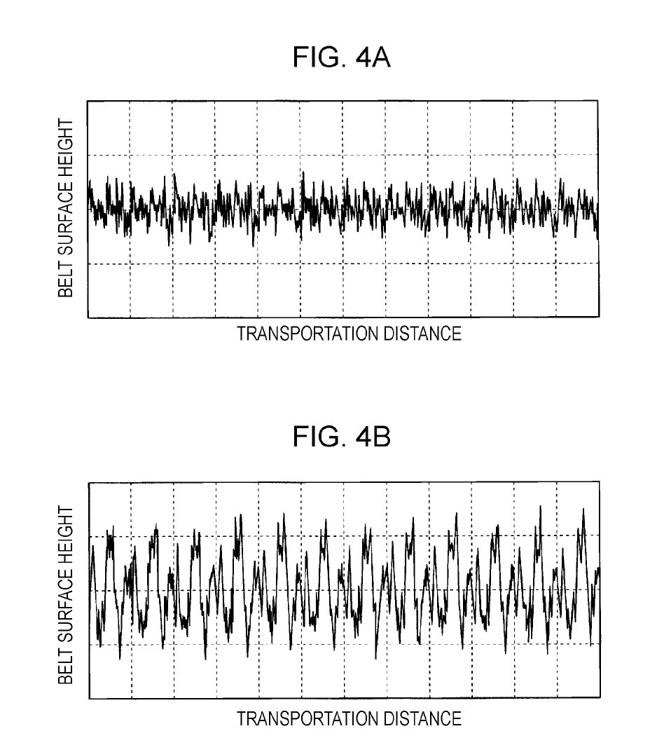

In addition, by preventing the change in the attraction of the suction unit 2 on the transporting belt 6, the flutter of the transporting belt 6 can be suppressed as shown in FIG. 4A. The dot superposition accuracy can be improved, and therefore the quality of recorded image can be improved.

The frictional resistance between the transporting belt 6 and the suction unit 2 can be prevented from increasing, and therefore the accuracy of transportation of the printing medium 5 can be improved.

FIG. 4B shows the result of an experiment that measures the magnitude of flutter of the transporting belt 6 when the transporting belt 6 is not sucked against the suction unit 2. It can be confirmed that the magnitude of flutter of the transporting belt 6 when the transporting belt 6 is sucked against the suction unit 2, that is, the experimental result shown in FIG. 4A is smaller.

In the case of sucking the transporting belt 6 by negative pressure, compared to, for example, the case of electrostatically attracting the transporting belt 6 onto the suction unit 2, the generation of noise can be restricted, and the magnetic signals for detecting the position of the transporting belt 6 can be stably obtained from the magnetic encoder 3.

In the case of electrostatically attracting the transporting belt 6 onto the suction unit 2, electrostatic noise is generated, the magnetic signals output from the magnetic encoder 3 are destabilized, and therefore the position of the transporting belt 6 cannot be detected normally.

(2) Since the flat plate member 15 is disposed under the ink jet heads 22₁ to 22₄, that is, opposite the nozzles of the ink jet heads, the transporting belt 6 is sucked against the flat portion at the positions where ink droplets are discharged by the ink jet heads 22₁ to 22₄, the flatness at the positions can be improved, and the distance between the ink jet heads 22₁ to 22₄ and the printing medium 5 can be prevented from changing.

(3) In addition, since the contact surface of the suction unit 2 in contact with the transporting belt 6 is coated with a material having a low coefficient of friction, the sliding load can be reduced when the transporting belt 6 slides on the upper surface of the suction unit 2, and the accuracy of transportation of the printing medium 5 can be improved.

(4) In addition, since the contact surface of the transporting belt 6 in contact with the suction unit 2 is coated with a material having a low coefficient of friction, the sliding load can be reduced when the transporting belt 6 slides on the upper surface of the suction unit 2, and the accuracy of transportation of the printing medium 5 can be improved.

(5) The suction unit 2 has the flat plate member 15 having the through-holes 18 for generating negative pressure formed in the contact surface thereof in contact with the transporting belt 6. However, the invention is not limited to this.

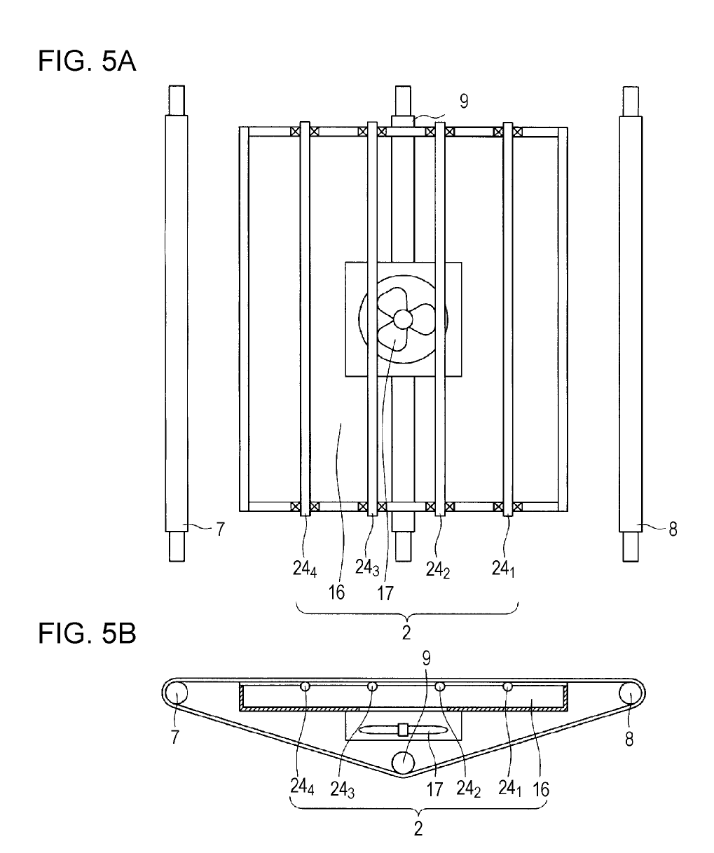

Instead of the flat plate member 15, the suction unit 2 may have, for example, a plurality of rollers 24₁ to 24₄ provided in the contact surface thereof in contact with the transporting belt 6, as shown in FIGS. 5A and 5B. The rollers are disposed at regular intervals in the direction of transportation of the printing medium 5. During the transportation of the printing medium 5, the rollers are in contact with the lower surface of the transporting belt 6 so as to support the transporting belt 6 and rotate in the moving direction of the transporting belt 6.

With the rotation of the transporting belt 6, the rollers 24₁ to 24₄ in contact with the transporting belt 6 rotate. Therefore, the sliding load can be reduced when the transporting belt 6 slides on the upper surface of the suction unit 2, and the accuracy of transportation of the printing medium 5 can be improved.

(6) The rollers 24₁ to 24₄ may be disposed along and opposite the nozzles of the ink jet heads 22₁ to 22₄. At the positions where ink droplets are discharged by the ink jet heads 22₁ to 22₄, the flatness of the printing medium 5 transported by the transporting belt 6 can be improved, and the distance between the ink jet heads 22₁ to 22₄ and the printing medium 5 can be prevented from changing.

### Second Embodiment

Next, a second embodiment of an ink jet printer of the present invention will be described with reference to the drawings.

The second embodiment differs from the first embodiment in that two units each including transporting belts and ink jet heads are tandemly arranged in the transportation direction.

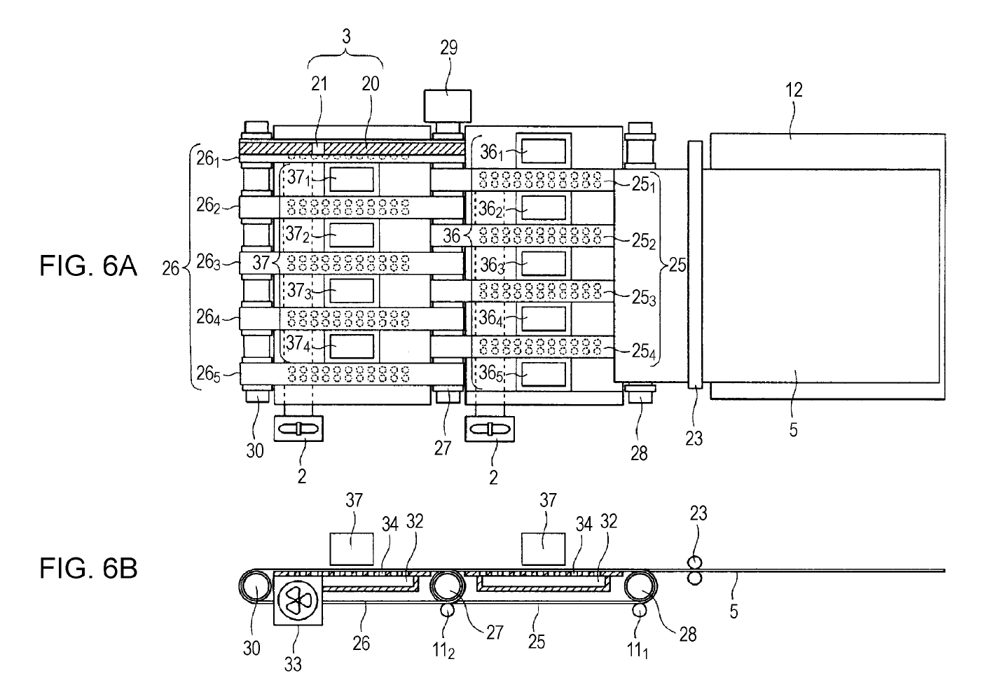

Specifically, as shown in FIGS. 6A and 6B, a paper transporting unit 1 includes an upstream transportation unit 25 and a downstream transportation unit 26 disposed downstream of the upstream transportation unit 25.

The upstream transportation unit 25 includes a plurality of transporting belts 25₁ to 25₄ disposed at predetermined intervals in a direction perpendicular to the direction of transportation of a printing medium 5, a drive roller 27 and an upstream idler roller 28 around which the transporting belts 25₁ to 25₄ are stretched, and a transportation section drive motor 29 that rotationally drives the drive roller 27.

Rotational driving of the transportation section drive motor 29 rotates the transporting belts 25₁ to 25₄. A charging roller 11₁ electrostatically charges the transporting belts 25₁ to 25₄. The printing medium 5 fed from the paper feed section is electrostatically attracted onto the upper surfaces of the transporting belts 25₁ to 25₄ and is transported under an upstream head unit 36 (described below) and then onto the downstream transportation unit 26.

The downstream transportation unit 26 includes a plurality of transporting belts 26₁ to 26₅ disposed at predetermined intervals in a direction perpendicular to the direction of transportation of the printing medium 5 and so that the transporting belts 25₁ to 25₄ and 26₁ to 26₅ are staggered in plan view, and the drive roller 27 (shared with the upstream transportation unit 25) and a downstream idler roller 30 around which the transporting belts 26₁ to 26₅ are stretched.

Rotational driving of the transportation section drive motor 29 rotates the transporting belts 26₁ to 26₅. The printing medium 5 transported from the upstream transportation unit 25 is electrostatically attracted onto the upper surfaces of the transporting belts 26₁ to 26₅ and is transported under a downstream head unit 37 (described below) and then to the paper ejection section 13.

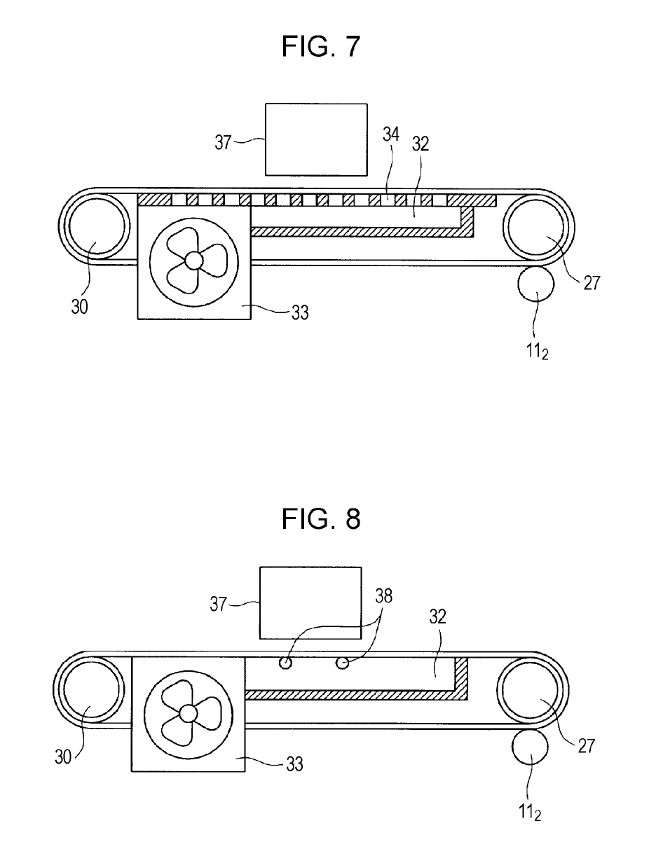

Suction units 2 are disposed inside the transporting belts 25₁ to 25₄ of the upstream transportation unit 25 and inside the transporting belts 26₁ to 26₅ of the downstream transportation unit 26. As shown in FIG. 7, each suction unit 2 includes flat plate members 31, suction chambers 32, and a suction fan 33.

The flat plate members 31 are disposed opposite the nozzles of the upstream head unit 36 (described below) and the nozzles of the downstream head unit 37 (described below) are in contact with the lower surfaces of the transporting belts 25₁ to 25₄ and the lower surfaces of the transporting belts 26₁ to 26₅ so as to support the transporting belts 25₁ to 25₄ and the transporting belts 26₁ to 26₅, and have through-holes 34 provided in the contact surfaces thereof in contact with the transporting belts 25₁ to 25₄ and 26₁ to 26₅.

The suction chambers 32 are disposed so as to cover the lower surfaces of the flat plate members 31. The suction chambers of each of the upstream and downstream suction units are communicated with each other. The suction fans 33 sucks in air to generate negative pressure in the through-holes 34 in the contact surfaces of the flat plate members 31 in contact with the transporting belts 25₁ to 25₄ and 26₁ to 26₅ and so that the transporting belts 25₁ to 25₄ and 26₁ to 26₅ are sucked against the contact surfaces.

The suction fans 33 are rotationally driven by fan motors (not shown), suck in the air in the suction chambers 32, and discharges the air downward.

A magnetic encoder 3 detects positional information of the transporting belt 26₁, and outputs the detection result to a head unit 4.

The head unit 4 includes the upstream head unit 36 disposed over the upstream transportation unit 25 and the downstream head unit 37 disposed over the downstream transportation unit 26.

The upstream head unit 36 is disposed over the transporting belts 25₁ to 25₄ of the upstream transportation unit 25 and includes a plurality of ink jet heads 36₁ to 36₅ each having Y, M, C, and K nozzle rows arranged in the direction of transportation of the printing medium 5.

The upstream head unit 36 performs printing by discharging ink droplets downward from the nozzle rows of each of the ink jet heads 36₁ to 36₅ on the basis of positional information of the transporting belt 26₁ of the downstream transportation unit 26 output from the encoder sensor 21.

The downstream head unit 37 is disposed over the transporting belts 26₁ to 26₅ of the downstream transportation unit 26 and includes a plurality of ink jet heads 37₁ to 37₄ each having Y, M, C, and K nozzle rows arranged in the direction of transportation of the printing medium 5.

The downstream head unit 37 performs printing in the regions where the upstream head unit 36 does not perform printing, by discharging ink droplets downward from the nozzle rows of each of the ink jet heads 37₁ to 37₄ on the basis of positional information of the transporting belt 26₁ of the downstream transportation unit 26 output from the encoder sensor 21.

In this embodiment, the flat plate members 31 have the through-holes 34 for generating negative pressure formed in the contact surfaces thereof in contact with the transporting belts 25₁ to 25₄ of the upstream transportation unit 25 and the transporting belts 26₁ to 26₅ of the downstream transportation unit 26. However, the present invention is not limited to this.

Instead of the flat plate members 31, the suction units 2 may have, for example, a plurality of rollers 38 provided in the contact surfaces thereof in contact with the transporting belts 25₁ to 25₄ and 26₁ to 26₅, as shown in FIG. 8. The rollers 38 are disposed at regular intervals in the direction of transportation of the printing medium 5. The rollers are in contact with the transporting belts 25₁ to 25₄ of the upstream transportation unit 25 and the transporting belts 26₁ to 26₅ of the downstream transportation unit 26 so as to support the transporting belts 25₁ to 25₄ and 26₁ to 26₅, and rotate in the moving direction of the transporting belts 25₁ to 25₄ and 26₁ to 26₅.

With the rotation of the transporting belts 25₁ to 25₄ and 26₁ to 26₅, the rollers 38 in contact with the transporting belts 25₁ to 25₄ and 26₁ to 26₅ rotate. Therefore, the sliding load can be reduced when the transporting belts 25₁ to 25₄ and 26₁ to 26₅ slide on the upper surfaces of the suction units 2, and the accuracy of transportation of the printing medium 5 can be improved.

The rollers 38 may be disposed along and opposite the nozzles of the upstream head unit 36 and the downstream head unit 37. At the positions where ink droplets are discharged by the upstream and downstream head units 36 and 37, the flatness of the printing medium 5 transported by the transporting belts can be improved, and the distance between the upstream and downstream head units 36 and 37 and the printing medium 5 can be prevented from changing.

What is claimed is:

1. A printer comprising:
at least one transporting belt that transports a printing medium while electrostatically attracting the printing medium;
a liquid ejecting head that ejects liquid droplets onto the printing medium transported by the transporting belt and thereby performs printing; and
a negative pressure generator that is in contact with the inner surface of the transporting belt and supports the transporting belt and that has a suction opening for generating negative pressure formed in a contact surface thereof in contact with the transporting belt,
wherein the transporting belt is a substantially airtight member.

2. The printer according to claim 1, wherein the transporting belt is a member without through-holes.

3. The printer according to claim 1, wherein the negative pressure generator has a low friction member on the contact surface thereof in contact with the transporting belt.

4. The printer according to claim 1, wherein the transporting belt has a low friction member on a contact surface thereof in contact with the negative pressure generator.

5. The printer according to claim 1, wherein the negative pressure generator has a plurality of rollers in the contact surface thereof in contact with the transporting belt, the plurality of rollers being disposed at predetermined intervals in the direction of transportation of the printing medium and rotating in the moving direction of the transporting belt.

6. The printer according to claim 5, wherein the rollers are disposed opposite nozzles of the liquid ejecting head.

7. The printer according to claim 1, wherein the at least one transporting belt includes a plurality of transporting belts disposed at predetermined intervals in a direction perpendicular to the direction of transportation of the printing medium, and the liquid ejecting head ejects liquid droplets onto a region of the printing medium out of contact with the transporting belts.
